(19) United States
(12) Patent Application Publication
(10) Pub. No.: US 2006/0072714 A1
(43) Pub. Date: Apr. 6, 2006

(54) Integrated voice record and playback systems having indicator for the presence of new recorded audio messages

(76) Inventors: Andreas von Sneidern, Sunnyvale, CA (US); Geoffrey B. Jackson, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/950,067

(22) Filed: Sep. 24, 2004

(51) Int. Cl. H04M 1/64

(52) U.S. Cl. 379/88.12

(57) ABSTRACT

Integrated voice record and playback systems having indicator for the presence of new recorded audio messages. The voice record and playback integrated circuits include circuitry for the sensing of the recording of a new message and the generation of a pulsing signal which can be used to pulse an external light emitting diode as an indicator of the existence of a new message, or to trigger the repetitive playback of a prerecorded signal to the external speaker used with the voice record and playback system to provide an audible indicator of the existence of a new message. Timing of the pulsing circuit may be controlled using the external capacitor normally used as part of an AGC circuit, thereby achieving a new message indicator with a minimum, if any, extra components. Various embodiments are disclosed, including various methods of disabling the indicator on playback of the message or messages.

### BACKGROUND OF THE INVENTION

1. Field of the Invention

This invention generally relates to the field of integrated circuits and provides a method for quickly determining the presence of new recordings on an audio storage system.

2. Prior Art

The present invention solves the problem of easily determining if a new message has been recorded on a voice recording chip and not yet been played back. The invention provides a single chip, low complexity and low power solution by integrating the pulse generation into the audio storage chip itself. Other systems, such as telephone answering machines or cell phones, provide visual indication that a new message is recorded. Those devices usually require external circuits such as clocks, discrete pulse train generators or an external micro controller to provide a new message indication. Previous versions of the ChipCorder® voice and digital data record and playback systems on a single chip sold by Winbond Electronics Corporation of America, assignee of the present invention, have been widely used in voice recording and playback applications, but a separate microcontroller is needed to manage recording status and message handling. These chips are capable of storing analog samples of an input signal such as an audio signal, each sample in a respective single floating gate storage cell, and playing the samples back to reproduce the stored audio signal.

In applications which demand simplicity, small circuit size, and low cost, it would be desirable to have an efficient single chip recording and playback device which provides an indicator to tell the user that a message has been recorded and is ready for playback. In addition, it is desirable to make use of circuit elements that already exist in the record and playback circuitry so that minimum additional cost is incurred.

### BRIEF DESCRIPTION OF THE DRAWINGS

FIG. 1 is a state diagram illustrating an exemplary functionality of an embodiment of the present invention.

FIG. 2 is a circuit diagram for a flasher enable circuit that may be used with the present invention.

FIG. 3 shows an embodiment whereby the two control signals FLASH_ENB and FLASH_DISB can be used to set and reset the flasher control, respectively.

FIG. 4 shows an embodiment in which the volatile storage flip-flop has been replaced with a non-volatile memory element.

FIG. 5 shows an exemplary flashing circuit in accordance with the present invention.

FIG. 6 shows an exemplary circuit similar to that of FIG. 5, but having the capability of generating a visible signal, an audible signal or both.

FIG. 7 shows the timing and shape of the pulses generated by the flashing circuit of FIG. 5.

FIG. 8 shows the actual active low pulse of FIG. 7 taken on an expanded time scale to show the active pulse length.

### DETAILED DESCRIPTION OF THE PREFERRED EMBODIMENTS

The preferred embodiments of the present invention are intended to be embedded in new versions of the ChipCorder® voice and digital data record and playback systems on a single chip to provide a low cost and low power single chip method of indicating a newly recorded message. Such an audio storage chip including this invention provides an indicator that a message has been recorded but not yet played back by providing a pulsing signal that can be used to drive an LED indicator or other optical and/or non optical indicator such as an audio indicator.

In one aspect, the present invention comprises a pulse generator integrated into an audio recording chip, the pulse generator being used to provide an indicator that a new message is available for playback.

In one embodiment, the invention comprises a ChipCorder® type audio recording and playback integrated circuit having an integrated, on-chip pulse generator capable of generating a low duty cycle pulse train of 1-2 Hz frequency using only an LED as a visual indicator, and/or the speaker used with the audio recording and playback integrated circuit to provide an audio indication of the presence of a new message. In the case of an audio new message signal, all other components are integrated in the circuit, or otherwise already present for the basic recording and playback functions of the ChipCorder® circuit. In use, the message record and playback signals are normally implemented using push buttons. The very high level of integration allows incorporation in products having a small enclosure, including a battery, microphone and speaker.

While the equivalent circuit of the invention can be built using external circuits, the invention provides lower power consumption, reduced size and lower total cost. In the case of a visual new message signal, the only additional components for providing a visual message indicator are an LED and a current limiting resistor. The on-chip circuit reuses components normally used for audio recording to drive the flashing LED, thus providing this circuit at virtually no extra cost.

The normal application of the circuit for an audio playback and recording system includes separate push buttons for recording and playing back messages. The application normally implements a functionality where a recording is done for as long as the record push button is pressed.

Using one embodiment of this invention, as shown in FIG. 1, when the record button is released, the LED flashing circuit integrated into the ChipCorder® circuit will be enabled and sends a pulsing signal to the LED, thereby providing an optical indication that a new message is recorded. Upon activation of a play operation, the flashing circuit is disabled and remains non operational until another message is recorded. The flashing circuitry is fully integrated in the ChipCorder® circuit and requires no external circuitry while providing very low power consumption.

Although a push button operation is described above, the control is not limited to mechanical switches, and any method can be used to provide signals on the record and play pins.

An alternative signal flow would cause the indicator to stop flashing at the end of the recorded message playback instead of when the play signal is activated. This would allow the LED to continue flashing if the person listening to the message decides to stop playback before the end of the message. The message would then be considered still new.

The flashing circuit re-uses external components used for automatic gain control for timing generation, as recording and LED flashing will never be done at the same time.

In one specific embodiment of the present invention, the system does not allow the indicator to maintain the pulsing state after playback of a message is complete. Normally once the playback is completed the first time, the device appears not to have any new messages.

An alternative implementation would include a separate mechanism for enabling the pulsing circuit. One exemplary use would be a message intended for more than one listener. In such an alternative embodiment, a separate flash-enable input signal can be provided to the “Indicator Flashing” state to restart the pulsing circuit, and it will then make the device appear to still have a new message.

Another alternative embodiment of the present invention provides a non-volatile memory that stores the state of the flashing indicator when power is removed. This allows for flashing to resume after power is restored. In this embodiment, the flash-enable input signal can be derived from a user button input, an outside control signal, or from the status saved in the non-volatile memory storage.

Technical Description

The flashing circuit of the preferred embodiment consists of two parts, a pulse generator circuit generating the actual pulse train and a control circuit enabling and disabling the flashing circuit as required by the current mode.

Flasher Enable Circuit

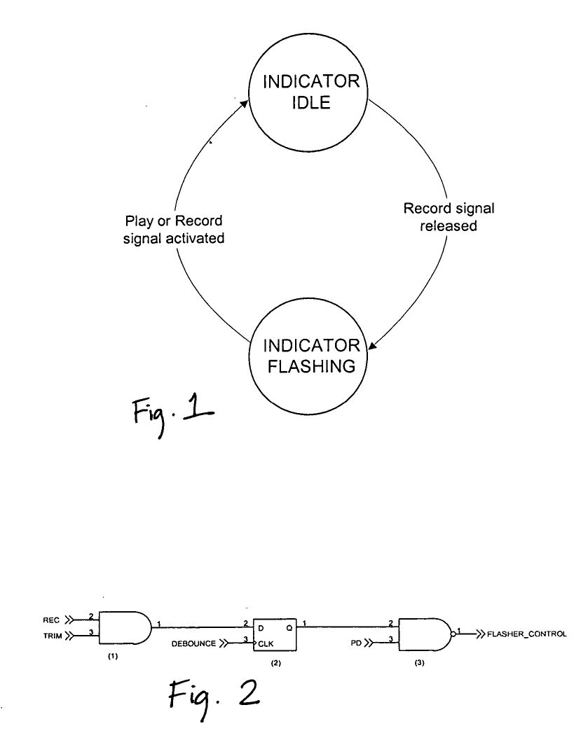

The control circuit generates a signal that enables and disables the flashing circuit such as by using the circuit of FIG. 2. The function selector AND gate enables the flashing circuit when the record signal REC is released (goes high), though the flashing circuit can be permanently disabled by a factory set feature switch (TRIM). The debounce clock ensures a stable signal out of the D Flip Flop. The debounce signal indicates that a chip function has started. This could be a PLAY or REC operation. On the edge of this signal the REC control signal is latched in the D flip flop (as long as the function is enabled with the TRIM signal high). If the operation was a record, when the device powers down (PD high), the flasher function is enabled. If the operation was a play, then a low would be latched in the D flip flop and the flasher would not operate. Finally, the control switch uses a NAND gate 24 that disables the flasher when the chip exits power down mode. For a multiple message device, this logic may be more complex. Ideally, one would detect that the last message has been played before disabling the flasher.

The chip is in power down mode whenever it is not playing back or recording, so either a playback or record command would stop the flashing circuit, which would then be restarted at the end of the record or playback period. This functionality is shown in the state machine previously described with respect to FIG. 1.

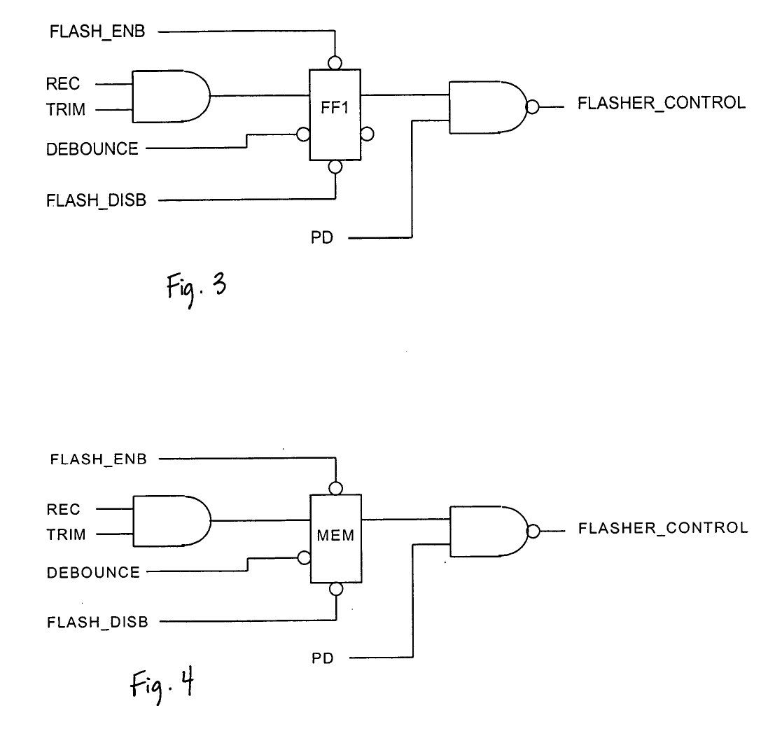

As described earlier, in an alternative embodiment of the present invention, a separate flash-enable input signal is provided to the “Indicator Flashing” state to restart the pulsing circuit, after which it will then make the device appear to still have a new message. FIG. 3 shows an embodiment of this whereby the two control signals FLASH_ENB and FLASH_DISB can be used to set and reset the flasher control respectively. These signals are provided by on-chip logic and may be triggered by control signals applied to the chip, for instance through a serial interface. In this case an external controller can decide when the device should flash or not. The advantages still remain to the single chip solution as the external controller can power down/off completely and the low power flashing can be generated by the chip.

Another alternative embodiment of the present provides a non-volatile memory (MEM) that stores the state of the flashing indicator when power is removed. This allows for flashing to resume after power is restored. In this embodiment, the volatile storage flip-flop (FF1) is replaced with a non-volatile memory element as shown in FIG. 4. This can be programmed by either the FLASH_ENB or detection of record and erased by the FLASH_DISB signal.

The scheme can also be extended to a multiple message device. The simplest embodiment of this would be to enable the flashing whenever a new message is recorded and disable upon any playback. A true new message indication can be implemented using the external FLASH_ENB and FLASH_DISB control signals where external logic or micro-controller can keep track of how many messages have been recorded and how many have been played back.

Flashing Timing Generation

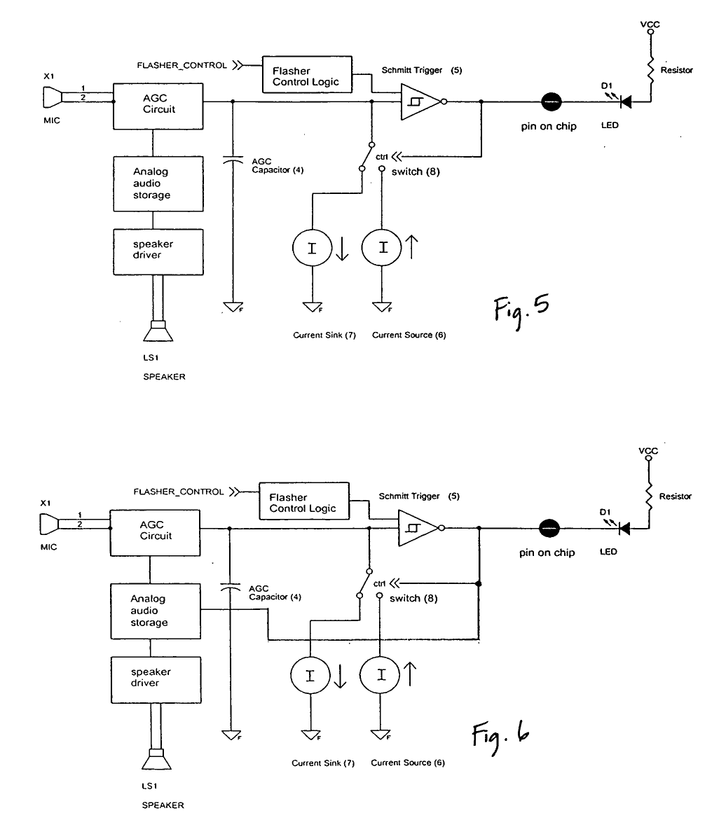

The flashing circuit shown in FIG. 5 uses a Schmitt Trigger (5) to generate a pulse train from the voltage of a capacitor that is alternately charged and discharged. The circuit uses the external AGC capacitor (4) for this purpose. The chip normally only uses the AGC capacitor while recording, and the chip is always in power on mode during recording. The LED flasher is only active during power down, so there is no interference between the systems. The AGC capacitor (4) is shared between the AGC circuit and the pulse generator as shown in FIG. 5. This arrangement allows for the flashing circuit to be implemented without adding external components.

The output of the Schmitt trigger (5) controls a switch that will connect the capacitor to either a current source (6) or a current sink (7). This creates a cycle where the capacitor is charged by the current source until the voltage goes above the threshold of the Schmitt trigger. The Schmitt trigger then changes the switch to the current sink and discharges the capacitor. When the voltage on the capacitor has dropped to below the lower threshold of the Schmitt trigger, the switch toggles again and the capacitor will be charged by the current source and the pattern repeats. The Schmitt trigger used in an exemplary implementation has switching voltages of VCC/2 at the high end and about 0.7V lower for the low switching point.

The ratio of the current source to sink determines the time it takes to charge and discharge the capacitor that in turn determines the duty cycle of the pulse train. In this implementation, the output pin is high to turn the LED off and low during a short time to provide the flashing signal. The LED must be connected to a supply voltage as shown in FIG. 5 if this polarity of implementation is used.

Thus in one particular embodiment of the present invention, the flashing circuit state is maintained while power is applied to the part. If power is removed, and then re-applied, the flasher will not restart even if it was flashing when power was removed. In an alternative embodiment of the present invention previously described, a separate flash-enable input signal to the “Indicator Flashing” state is provided to restart the pulsing circuit, and it will then make the device appear to still have a new message. Another alternative embodiment of the present invention provides a non-volatile memory that stores the state of the flashing indicator when power is removed. This allows for flashing to resume after power is restored. In this embodiment, the flash-enable input signal can be derived from a user button input, an outside control signal, or from the status saved in the non-volatile memory storage.

In the above discussion, the message indicator generally is an LED flasher. In another embodiment, the indicator can be a beeping sound generated through the speaker normally used with the record and playback system. This can be implemented, by way or example, using a single-frequency signal stored in a reserved area of the record and playback system. Like the flashing LED, the beeping sound should be a low duty cycle beeping to conserve battery power. One implementation for achieving this is shown in FIG. 6, where the output of the Schmidt trigger (5) is also used to trigger the playback of a stored signal to indicate the presence of an unread message. Of course the parameters may be changed, if desired, to provide different time periods, particularly a shorter beep than normally would be used for a flashing LED, as an audible signal is readily sensed without requiring the visual attention of the user. Such shorter time period, if desired, could be provided by varying the current sources hereinbefore described, or by simply pre-recoding a shorter signal that is triggered by the Schmidt trigger pulse, but completes playback of the signal before the end of the pulse.

Also, referring again to FIG. 6, the Figure may suggest that both visual and audible indications of a new message need be provided with this embodiment. Both can be provided, though either may be individually provided depending on the implementation. By way of example, if only an audible signal is desired, the external resistor and diode may simply be deleted. If only the visual signal is desired, then the recorded signal may be a uniform signal not generating a tone, or may simply be an “end of message” signal or equivalent to terminate the playback of the signal before it starts.

Example Timing

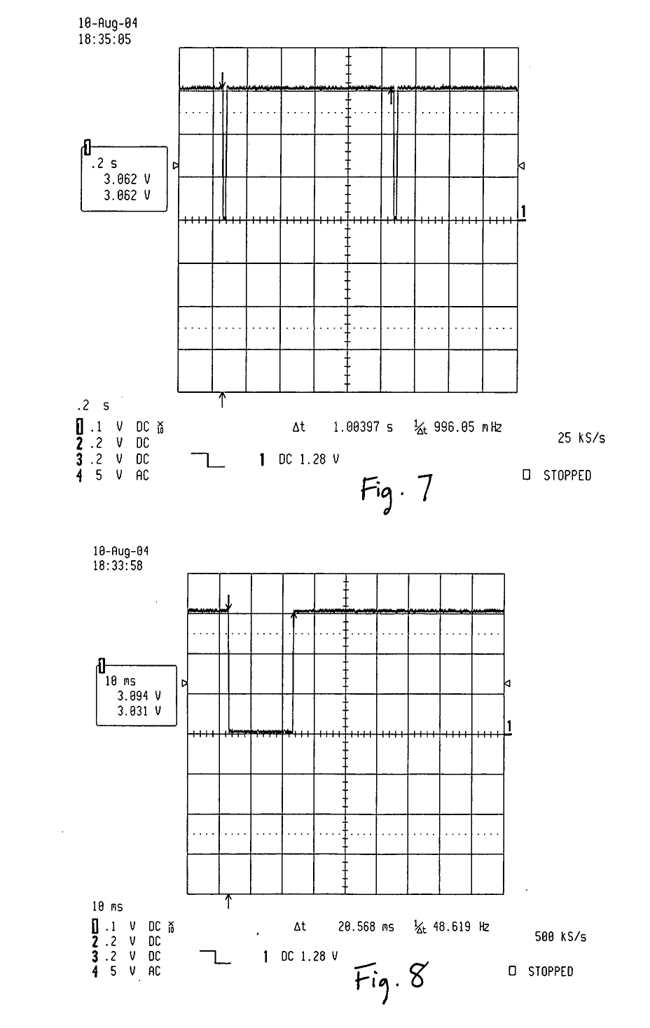

In one implementation, a flashing frequency of 1 second was chosen to provide easy detection of the flasher being active. The pulse length is about 20 milliseconds, long enough to pulse the light on the LED but short enough to keep power consumption low. FIG. 7 shows the timing and shape of the pulses. Note the active low pulses as previously described. The timing indicators in FIG. 7 show the flashing period to be 1 second. FIG. 8 shows an actual active low pulse taken on an expanded time scale to show the active pulse length. The pulse length here is around 20 milliseconds to provide a visible indication when using an LED. Of course these timings can be varied as desired to balance ease of detection of the flashing LED and battery life in battery powered applications.

Advantages

The present invention provides a message indicator method and apparatus with minimal external components for lowest complexity and with lower power consumption compared to other flashing circuits to provide a single chip circuit integrating audio and flashing functions in a smaller board area. The invention reuses circuits in the audio recording part of the chip to provide the flashing mechanism with minimal extra cost compared to external pulse generators. While the preferred embodiments of the invention have been disclosed and described with respect to the ChipCorder® voice and digital data record and playback systems capable of storing analog samples of an input signal such as an audio signal, each sample in a respective single floating gate storage cell, the invention is also applicable to other integrated circuit voice and digital data record and playback systems such as, by way of example, integrated circuits that digitizes each audio sample and stores the digital values of the samples for later playback and reconversion to analog form.

While the present invention may be used in various products, one use would be as an electronic POST-IT type note (POST-IT is a registered trademark of the 3M Company) where an application implementing this invention would provide a method to record and play back a message by a very small an inexpensive device. The LED flasher or audible signal provided by this invention would inform the user that a new message is available to play back. The enclosure might include a magnet or spring loaded clip for simple attachment to a magnetic or non magnetic surface, typically in highly visible locations such as, buy way of example, a refrigerator door or a document edge.

While certain preferred embodiments of the present invention have been disclosed and described herein, it will be understood by those skilled in the art that various changes in form and detail may be made therein without departing from the spirit and scope of the invention. Similarly, the various aspects of the present invention may be advantageously practiced by incorporating all features or various sub-combinations of features as desired.

What is claimed is:

1. An audio record and playback integrated circuit for providing new message indication comprising, as a single integrated circuit:
audio record and playback circuitry for recording and playing back samples of an audio signal provided thereto;
pulsing circuitry;
circuitry for detecting the recording of a message and initiating the pulsing circuitry; and,
the circuitry for detecting the recording of a message also detecting the playback of a message to disable the pulsing circuitry.

2. The integrated circuit of claim 1 wherein the pulsing circuitry includes circuitry for coupling to an external AGC capacitor for use of the capacitor for timing of the pulsing circuitry when the audio record and playback circuitry is neither recording nor playing back samples of an audio signal.

3. The integrated circuit of claim 1 wherein the pulsing circuitry includes at least one output pin for coupling to an external light emitting diode.

4. The integrated circuit of claim 1 wherein the audio record and playback circuitry has a speaker output for connecting to an external speaker, the pulsing circuitry being coupled to the audio record and playback circuitry for causing the repetitive playback of a signal through the speaker output.

5. The integrated circuit of claim 1 wherein the circuitry for detecting the recording of a message detects the beginning of playback of a message to disable the pulsing circuitry.

6. The integrated circuit of claim 1 wherein the circuitry for detecting the recording of a message detects the completion of the playback of a message to disable the pulsing circuitry.

7. The integrated circuit of claim 1 further comprising circuitry for re-enabling the pulsing circuitry after playback of a message upon receipt of a user input directing such re-enabling.

8. The integrated circuit of claim 1 further comprised of a non-volatile memory for storing the status of the pulsing circuitry during periods of power depravation.

9. The integrated circuit of claim 1 wherein the audio record and playback circuitry is capable of recording multiple messages for subsequent playback.

10. The integrated circuit of claim 1 wherein the pulsing circuitry comprises circuitry for pulsing for approximately 20 milliseconds every one to two seconds.

11. The integrated circuit of claim 1 wherein the audio record and playback circuitry will store each sample in a respective single floating gate storage cell.

12. An audio record and playback integrated circuit for providing new message indication comprising, as a single integrated circuit:
audio record and playback circuitry for responsive to record and playback control signals for recording and playing back samples of an audio signal provided thereto, respectively;
pulsing circuitry;
circuitry coupled to the record control signal for detecting the recording of a message and initiating the pulsing circuitry;
the circuitry for detecting the recording of a message also being coupled to the playback control signal for detecting the playback of a message to disable the pulsing circuitry.

13. The integrated circuit of claim 12 wherein the pulsing circuitry includes circuitry for coupling to an external AGC capacitor for use of the capacitor for timing of the pulsing circuitry when the audio record and playback circuitry is neither recording nor playing back samples of an audio signal.

14. The integrated circuit of claim 12 wherein the pulsing circuitry includes at least one output pin for coupling to an external light emitting diode.

15. The integrated circuit of claim 12 wherein the audio record and playback circuitry has a speaker output for connecting to an external speaker, the pulsing circuitry being coupled to the audio record and playback circuitry for causing the repetitive playback of a signal through the speaker output.

16. The integrated circuit of claim 12 wherein the circuitry for detecting the recording of a message detects the beginning of playback of a message to disable the pulsing circuitry.

17. The integrated circuit of claim 12 wherein the circuitry for detecting the recording of a message detects the completion of the playback of a message to disable the pulsing circuitry.

18. The integrated circuit of claim 12 further comprising circuitry for re-enabling the pulsing circuitry after playback of a message upon receipt of a user input directing such re-enabling.

19. The integrated circuit of claim 12 further comprised of a non-volatile memory for storing the status of the pulsing circuitry during periods of power depravation.

20. The integrated circuit of claim 12 wherein the audio record and playback circuitry is capable of recording multiple messages for subsequent playback.

21. The integrated circuit of claim 12 wherein the pulsing circuitry comprises circuitry for pulsing for approximately 20 milliseconds every one to two seconds.

22. The integrated circuit of claim 12 wherein the audio record and playback circuitry will store each sample in a respective single floating gate storage cell.
